(19) United States
(12) Patent Application Publication
(10) Pub. No.: US 2013/0164700 A1
(43) Pub. Date: Jun. 27, 2013

(54) SINTERING METHOD FOR A TANTALUM CAPACITOR ANODE BLOCK

(71) Applicant: Taike Technology (Suzhou) Co., Ltd., Suzhou City (CN)

(72) Inventor: Yau Min LIN, Taipei City (TW)

(73) Assignee: Taike Technology (Suzhou) Co., Ltd., Suzhou City (CN)

(21) Appl. No.: 13/682,142

(22) Filed: Nov. 20, 2012

(30) Foreign Application Priority Data
Dec. 23, 2011 (CN) 201110437023.5

(51) Int. Cl. H01G 4/008; H01G 13/04

(52) U.S. Cl. CPC H01G 4/008; H01G 13/04
USPC 432/13; 432/18; 432/23

(57) ABSTRACT

A sintering method for a tantalum capacitor anode block, characterized in that: inserting a tantalum anode block molded from a tantalum powder mixed with an adhesive into a drying oven injected with a degreasing solvent; conducting hermetically low temperature solvent catalytic wet dewaxing; conducting vacuum drying; and conducting vacuum sintering. The tantalum anode block is obtain by the present invention has high specific surface area and high porosity, so the specific capacity is high, current leakage is small, and the carbon content and oxygen content is reduced to 0.005%˜0.010% and 0.18%˜0.65%, respectively.

### BACKGROUND OF THE INVENTION

1. Field of the Invention

The present invention relates to a method of manufacturing a tantalum anode block, and more particularly to a method of conducting wet dewaxing onto a tantalum anode block then sintering the same.

2. The Related Art

In recent years, with the rapid development of personal computer, mobile phone, vehicle industry, the development of tantalum capacitor and electronic product is needed to be miniaturized and microminiaturized. Thus improving the tantalum powder of high quality and high specific capacity is a trend for the development of tantalum powder technology. However, owing to the granule of high specific capacity tantalum powder is small, the large surface area and strong activity, it easily results in loss of capacitance seriously after high temperature sintering. But under low temperature sintering, the shrinkage of tantalum anode block is small, sintering density is low, porosity is high and hence results in more openings. Owing to the refining reaction of impurities, the sintering operation thereof can not be conducted sufficiently so as to result in decrease in the index of electric property, like the pressure resistance and the current leakage of tantalum powder. Therefore, it is required to choose a suitable sintering system to guarantee to remove completely the harmful impurity from the tantalum anode block so as to obtain high specific capacity tantalum anode block is an urgent purpose of the technology research and development.

During the molding process of the tantalum anode block, in order to improve the fluidity of tantalum powder, the technology (technique) property, the density distribution of molded block, the quality of sintering, the contractility of molded block, it is generally required to add an appropriate amount of adhesive. The adhesives that widely used are paraffin melted in the gasoline, camphor melted in trichloroethane or hexane, glycerin melted in alcohol, stearic acid melted in alcohol and so on. These existing adhesives will result in an excess of carbon, oxygen and impurity in the substrate, and the content of impurity will directly affect the value of current leakage of tantalum capacitor, the flash voltage, the product reliability and lifespan. When the current flows through the region with the impurity existed therein, the temperature, rises to make the Ta₂O₅ at the periphery crystallized, cracks in the medium, result in the increase of current leakage, the decrease in pressure, and hence decreasing the tantalum anode block property. The worst problem is the capacitor breakdown.

According to the conventional technology, in order to reduce the harmful impurity in the substrate, it generally uses pre-burning process before sintering the tantalum anode block, namely, vacuum high-temperature degassing technique. During pre-burning process, when the vacuity meets the predetermined value, about 6.5'10⁻³Pa, the temperature starts rising. In order to prevent the breakdown of tantalum anode block because of exhausting the air too fast, the rising speed of temperature should not be too fast, generally around 350° C. or so, the adhesive can be evaporated completely. According to furnace load keep warm for a specific period of time, cool down the temperature to 80° C. or so. Such pre-sintering method needs higher temperature and the oven stays hot for a longer time, which results in time waste and power. Besides, owing to the existing of adhesive, after high temperature vacuum dewaxing, it is hard to avoid some carbon remaining in the tantalum powder, such that result in high current leakage of tantalum capacitor anode. The disclosure of patent number JP2-34701 and JP5-65502 related to relevant technology are limiting the development thereof due to the adhesive added thereto.

In recent years, due to a requirement of shrinking the size of the product is needed, as well as to increase the molding property of tantalum powder and in order to speed up the producing, the adhesive is not added. However, the price of tantalum powder is expensive, the use of adhesive can reduce the waste generated after molding and sintering, like bad angles and edges, cracking stratification ed or distortion, uneven shrinkage and so on. However, the practical operation result proves that the fluidity of tantalum powder with adhesive added therein is much better than without the adhesive added therein. Thus, as long as a guarantee of the tantalum powder in the tantalum anode block having high purity, the sintering temperature may be reduced, which, in turn, increase the specific capacity of tantalum powder and reduce the current leakage.

### SUMMARY OF THE INVENTION

In order to improve the problems mentioned above, a sintering method of the present invention for a tantalum capacitor anode block is provided. The tantalum anode block obtained by this sintering method can sustain high specific surface area and high porosity, high specific capacity, low current leakage, and the carbon content and the oxygen content may be reduced to 0.005%˜0.010% and 0.18%˜0.65%, respectively. The present method is a highly cost effective manufacturing and results in high specific capacity.

A sintering method of the present invention as described is disclosed below.

A sintering method for a tantalum capacitor anode block, comprising:

inserting a tantalum anode block, molded from a tantalum powder mixed with an adhesive, into a drying oven, into which a degreasing solvent is injected;

conducting hermetically low temperature solvent catalytic wet dewaxing;

conducting vacuum drying; and

conducting vacuum sintering;

wherein a specific capacity of the tantalum powder is 17˜150 KμF·V/g.

Also, the adhesive is selected from any one of paraffin (including paraffin of different fusing point), camphor, benzoic acid, glycerin or stearic acid(including stearic acid of different molecular formula).

Also, the degreasing solvent is selected from any one of ethanol, gasoline, hexane or trichloroethane.

Further, the drying oven is a stainless steel drying oven, the dewaxing temperature of hermetically low temperature solvent catalytic wet dewaxing ranges 60° C.˜80° C.

Apart from the aforementioned method, another sintering method is provided according to the present invention.

Repeatedly conducting hermetically low temperature solvent catalytic wet dewaxing onto the tantalum anode block in the drying oven for several times; and

conducting vacuum drying;

wherein the vacuum drying is conducted using a vacuum drying oven, the drying temperature is 60° C.˜95° C., and the vacuity is equal to or less than 0.5 Pa.

Moreover, during the vacuum sintering operation, the highest vacuum sintering temperature ranges 1200° C.˜1550° C., and the vacuity is (2.0˜5.0)×10⁻³Pa.

A sintering method of the present invention for sintering a tantalum capacitor anode block comprising:

molding an adhesive which is made from any one of paraffin(including paraffin of different fusing point), camphor, benzoic acid, glycerin or stearic acid(including stearic acid of different molecular formula) and a tantalum powder which specific capacity is 17˜150 KμF·V/g into a tantalum anode block;

inserting the tantalum anode block into a stainless steel oven which is injected with a degreasing solvent;

hermetically raising the heating temperature to 60° C.˜80° C. and repeatedly conducting solvent catalytic dewaxing treatment for several times;

inserting the tantalum anode block in a vacuum drying oven for drying;

putting the dried tantalum anode block in a vacuum oven for undergoing sintering operation, wherein the highest sintering temperature ranges 1200° C.˜1550° C.

The sintering method for the tantalum capacitor anode block may replace the conventional technique of high temperature vacuum dewaxing sintering, where the disadvantages exist. An efficient and economical method is provided to manufacture the high specific capacity tantalum capacitor. Deeply stripping the anode block impurity before the tantalum anode block is sintered may guarantee high purity of the tantalum powder. Wet dewaxing is conducted at the temperature ranging 60° C.˜80° C., which may avoid burned micropores to cause the difficulty of exhausting air result from high temperature vacuum dewaxing and high content oxygen may cause fusing bar phenomenon in this regard, and eliminate the limits of rising temperature speed, so that the anode block can rapidly exhaust gaseous impurities hence saving power and time.

As mentioned above, a dewaxing and sintering method for the tantalum capacitor anode block of the present is a technique of low temperature sintering, stable efficiency, short flow process, fine quality, which is a better technology of tantalum powder dewaxing sintering, which can reduce carbon content and oxygen content in tantalum powder to 0.005%˜0.010% and 0.18%˜0.65%, respectively under low temperature and shorter time when compared to the conventional method for vacuum high temperature dewaxing. The dewaxing temperature of the present invention is much lower than that of the conventional ones. Aforementioned conditions are provided to obtain desired high purity, high specific capacity and high porosity tantalum anode block. Using said sintering method can manufacture a tantalum anode block with high purity and well adjusted aperture such that to manufacture an anode of tantalum electrolytic capacitor with good property.

The embodiments for dewaxing and sintering of the tantalum anode block will be described in more detail in the following.

### BRIEF DESCRIPTION OF THE DRAWINGS

### Detailed Description of the Embodiments

### Embodiment 1

A sintering method is applied to degrease a tantalum anode block and sintering the same, includes: inserting a tantalum anode block, molded from tantalum powder mixed with an adhesive, into a drying oven injected with a degreasing solvent; conducting hermetically low temperature solvent catalytic wet dewaxing; conducting vacuum drying; and conducting vacuum sintering. The specific sintering method will be described below.

Firstly, mixing a tantalum powder which specific capacity is 50 KμF·Vg with an adhesive paraffin (including paraffin of different fusing point) then molding the mixture into a tantalum anode block. The tantalum anode block is inserted into a stainless steel oven, into which gasoline is injected so as immerse tantalum anode block therein. Hermetically raise the heating temperature to 80° C. then conduct solvent catalytic dewaxing treatment relative to the tantalum anode block. Aforementioned dewaxing treatment is repeatedly conducted for several times. The dewaxed tantalum anode block is placed into a vacuum water bath drying oven, the temperature of water bath is adjusted to 60° C. till the exhausted vacuity is 0.1 Pa and drying the dewaxed tantalum anode block for 3 hours. Afterward, put the dried tantalum anode block in a vacuum oven for undergoing sintering operation, where the highest sintering temperature is 1370° C., the vacuity is 2.0×10⁻³Pa. Using the LECO Carboxyhemoglobin analyzer to detect the tantalum anode block which has undergone the wet dewaxing and sintering operation, wherein the carbon content and oxygen content is 0.0064% and 0.25%, respectively.

### Embodiment 2

A sintering method is applied to degrease a tantalum anode block and sintering the same, includes: inserting a tantalum anode block, molded from tantalum powder mixed with an adhesive, into a drying oven injected with a degreasing solvent; conducting hermetically low temperature solvent catalytic wet dewaxing; conducting vacuum drying; and conducting vacuum sintering. The specific sintering method will be described as below.

Firstly, mixing a tantalum powder which specific capacity is 70 KμF·V/g with an adhesive camphor and then molding the mixture into a tantalum anode block. The tantalum anode block is inserted into a stainless steel oven, into which trichloroethane is injected to immerse the tantalum anode block therein. Hermetically raising the heating temperature to 75° C. then conduct solvent catalytic dewaxing treatment on the tantalum anode block. Aforementioned dewaxing treatment is repeatedly for several times. The dewaxed tantalum anode block is put in a vacuum water bath drying oven, the temperature of water bath is adjusted to 70° C. till the exhausted vacuity is 0.15 Pa, and drying the dewaxed tantalum anode block for 4 hours, and then putting the dried tantalum anode block in the vacuum oven for undergoing the sintering operation, where the highest sintering temperature is 1320° C., the vacuity is 2.5×10⁻³Pa. Using the LECO Carboxyhemoglobin analyzer to detect the tantalum anode block which has just undergone the wet dewaxing and sintering operation, where the carbon content and oxygen content is 0.0086% and 0.33%, respectively.

### Embodiment 3

A sintering method is applied to degrease a tantalum anode block and sintering the same, includes: inserting a tantalum anode block, molded from tantalum powder mixed with an adhesive, into a drying oven injected with a degreasing solvent; conducting hermetically low temperature solvent catalytic wet dewaxing; conducting vacuum drying; and conducting vacuum sintering. The specific sintering method will be described as below.

Firstly, mixing a tantalum powder which specific capacity is 80 KμF·V/g with an adhesive glycerin then molding the mixture into a tantalum anode block. The tantalum anode block is inserted into a stainless steel oven, into which ethanol is injected to immerse the tantalum anode block therein. Hermetically raising the heating temperature to 65° C. then conducting solvent catalytic dewaxing treatment on the tantalum anode block. The dewaxing treatment is repeatedly several times. The dewaxed tantalum anode block is put into a vacuum water bath drying oven, the temperature of water bath is adjusted to 80° C. till the exhausted vacuity is 0.12 Pa, and drying the dewaxed tantalum anode block for 3 hours, and then putting the dried tantalum anode block in the vacuum oven for undergoing sintering operation, where the highest sintering temperature is 1310° C., the vacuity is 1.8×10⁻³Pa. Using the LECO Carboxyhemoglobin analyzer to detect the tantalum anode block which has just undergone the wet dewaxed and sintering operation, where the carbon content and oxygen content is 0.0076% and 0.35%, respectively.

### Embodiment 4

Firstly, mixing a tantalum powder which specific capacity is 100 KμF·V/g with an adhesive benzoic acid then molding the mixture into a tantalum anode block. The tantalum anode block is inserted into a stainless steel oven, into which ethanol is injected to immerse the tantalum anode block therein. Hermetically raising the heatitn temperature to 60° C. then conducting solvent catalytic dewaxing treatment on the tantalum anode block. The dewaxing treatment is repeatedly for several times. The dewaxed tantalum anode block is put into a vacuum water bath drying oven, the temperature of water bath is adjusted to 80° C. till the exhausted vacuity is 0.15 Pa, and drying the dewaxed tantalum anode block for 4 hours, and then putting the dried tantalum anode block in the vacuum oven for undergoing sintering operation, where the highest sintering temperature is 1295° C., the vacuity is 2.0×10⁻³Pa. Using the LECO Carboxyhemoglobin analyzer to detect the tantalum anode block which has just undergone the wet dewaxed and sintering operation, where the carbon content and oxygen content is 0.0078% and 0.46%, respectively.

### Embodiment 5

Firstly, mixing a tantalum powder which specific capacity is 120 KμF·V/g with an adhesive stearic acid (including stearic acid of different molecular formula) then molding the mixture into a tantalum anode block. The tantalum anode block is inserted in a stainless steel oven, into which ethanol is injected to immerse the tantalum anode block therein. Hermetically raising the heating temperature to 60° C. then conducting solvent catalytic dewaxing treatment on the tantalum anode block. The dewaxing treatment is repeatedly for several times. The dewaxed tantalum anode block is put into a vacuum water bath drying oven, and the temperature of water bath is adjusted to 80° C. till the exhausted vacuity is 0.15 Pa, the drying ewaxed tantalum anode block for 4 hours, and then putting the dried tantalum anode block in the vacuum oven for undergoing sintering operation, where the highest sintering temperature is 1280° C., the vacuity is 2.0×10⁻³Pa. Using the LECO Carboxyhemoglobin analyzer to detect the tantalum anode block which has just undergone wet dewaxed and sintering operation, where the carbon content weight percent and oxygen content weight percent is 0.0083% and 0.62%, respectively.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A sintering method for a tantalum capacitor anode block, characterized in that:
inserting a tantalum anode block, molded from a tantalum powder mixed with an adhesive, into a drying oven, into which a degreasing solvent is injected;
conducting hermetically low temperature solvent catalytic wet dewaxing;
conducting vacuum drying; and
conducting vacuum sintering.

2. The sintering method of claim 1, wherein a specific capacity of the tantalum powder is 17˜150 KμF·V/g.

3. The method of claim 1, wherein the adhesive is selected from any one of paraffin(including paraffin of different fusing point), camphor, benzoic acid, glycerin or stearic acid (including stearic acid of different molecular formula).

4. The sintering sintering method of claim 1, wherein the degreasing solvent is selected from any one of ethanol, gasoline, hexane or trichloroethane.

5. The method of claim 1, wherein the drying oven is a stainless steel drying oven, the dewaxing temperature of hermetically low temperature solvent catalytic wet dewaxing ranges 60° C.˜80° C.

6. The sintering method of claim 1, wherein the method is further comprising:
repeatedly conducting hermetically low temperature solvent catalytic wet dewaxing onto the tantalum anode block in the drying oven for several times; and
conducting vacuum drying.

7. The sintering method of claim 1, wherein the vacuum drying is conducted by using a vacuum drying oven, the drying temperature is 60° C.˜95° C., and the vacuity is equal to or less than 0.5 Pa

8. The sintering method of claim 1, wherein during vacuum sintering, the highest vacuum sintering temperature ranges 1200° C.˜1550° C., and the vacuity is (2.0˜5.0)×10⁻³Pa.

9. A sintering method for sintering a tantalum capacitor anode block, characterized in that:
molding an adhesive which is made from any one of paraffin(including paraffin of different fusing point), camphor, benzoic acid, glycerin or stearic acid(including stearic acid of different molecular formula) and a tantalum powder which specific capacity is 17˜150 KμF·V/g into a tantalum anode block;
inserting the tantalum anode block into a stainless steel oven which is injected with a degreasing solvent;
hermetically raising the temperature to 60° C.˜80° C. and repeatedly conducting solvent catalytic dewaxing treatment onto the tantalum anode block for several times;
rolling the tantalum anode block in a vacuum drying oven and drying;
putting the dried tantalum anode block in a vacuum oven for undergoing sintering operation, wherein the highest sintering temperature ranges 1200° C.˜1550° C.
